(19) United States
(12) Patent Application Publication
(10) Pub. No.: US 2005/0201351 A1
(43) Pub. Date: Sep. 15, 2005

(54) Mobile communications system, mobile station apparatus, base station apparatus and a transmission rate control method

(75) Inventor: Fumiaki Nakao, Yokohama-shi (JP)

Correspondence Address: HOGAN & HARTSON L.L.P., 500 S. GRAND AVENUE, SUITE 1900, LOS ANGELES, CA, 90071-2611, US

(73) Assignee: KYOCERA CORPORATION

(21) Appl. No.: 11/067,134

(22) Filed: Feb. 24, 2005

(30) Foreign Application Priority Data
Feb. 27, 2004 (JP) 055543/2004
Mar. 31, 2004 (JP) 108550/2004

(51) Int. Cl. H04B 7/216

(52) U.S. Cl. 370/342

(57) ABSTRACT

In order to reduce the chances that decoding is disabled on a base station unit, in a mobile communications system conforming to the Code Division Multiple Access (CDMA) Standard including a base station unit and a mobile station unit, the mobile station unit changes the transmission rate of an information code so as to lower the transmission rate with a given timing.

### BACKGROUND OF THE INVENTION

The present invention relates to a mobile communications system, a mobile station unit, a base station unit and a transmission rate control method.

In a mobile communications system such as a cell phone system conforming to the CDMA (Code Division Multiple Access) Standard, when a mobile station unit performs communications or transmits a new information code, there may happen a case where a new call or the new information code originated from another mobile station unit cannot be decoded by a base station unit.

A communications signal of a mobile station unit acts as an interference wave for a communications signal of another. As the number of mobile station units engaged in communications increases in a base station unit, the volume of an interference wave (interference volume) received by the base station unit increases. In case the interference volume becomes excessive, the influence of an interference wave on a new call or a new information code originated from another mobile station unit cannot be neglected. When the influence of the interference wave is no longer negligible, a signal may be disrupted by a noise, which prevents decoding.

For example, in some systems which conform to the MC (Multi Carrier)-CDMA Standard used in CDMA2000 or DS (Direct Sequence)-CDMA Standard used in W-CDMA, a mobile station unit starts transmission at the lowest level of antenna power when transmitting a new information code in order to avoid the above problem. A communications signal with high antenna transmitting power (or a communications signal with a large amplitude) has a greater influence as an interference wave on other communications signals compared than a communications signal with a small amplitude. That is, a communication signal with a large amplitude increases the volume of an interference wave (interference volume). For this reason, the amplitude of a communications signal is reduced by first starting communications using the lowest level of antenna power to prevent an increase in the interference volume.

In a system described above, the antenna power is gradually increased thereafter in accordance with the receiving level of a pilot signal transmitted from a base station unit or the information on the interference volume noticed from the base station unit.

In this way, a related art communications system suppresses any mobile station unit from communicating with a base station unit using an abruptly high antenna power in order to avoid a situation where the interference volume in the base station unit becomes suddenly excessive thus disabling decoding. JP 2000-31944 A discloses an invention concerning a transmitter, a receiver and a data transmitting method which automatically switches between data transmission rates in accordance with the circuit status.

However in the above related art system, the noise immunity of the interference volume is not secured in the base station unit. For example, in case a large number of new information codes are transmitted at a time, the interference volume may suddenly become excessive, causing decoding to be unavailable in the base station unit.

### SUMMARY OF THE INVENTION

The invention has been accomplished in view of the above problems and has as an object to provide a mobile communications system, a mobile station unit, a base station unit and a transmission rate control method which can reduce the chances that decoding is disabled on a base station unit.

A mobile communications system according to one aspect of the invention for solving the above problems is a mobile communications system conforming to the Code Division Multiple Access (CDMA) Standard comprising a base station unit and a mobile station unit, wherein the mobile station unit comprises transmission rate storage means for storing a transmission rate of a signal transmitted from the mobile station unit, transmission rate lowering means for lowering the transmission rate of the signal transmitted from the mobile station unit below the transmission rate stored on the transmission rate storage means, and transmission rate recovery means for recovering the transmission rate of the signal transmitted from the mobile station unit to the transmission rate stored on the transmission rate storage means when a predetermined time has elapsed in case the transmission rate lowering means lowers the transmission rate below the transmission rate stored on the transmission rate storage means.

By doing so, it is possible to autonomously lower the transmission rate in a mobile station unit. In a mobile communications system conforming to the CDMA Standard, the transmission rate of a mobile station unit is generally correlated with the necessary transmitting power (antenna power). Thus, by autonomously lowering the transmission rate in a mobile station unit, it is possible to lower the transmitting power of the mobile station unit. According to the invention, it is possible to lower the transmitting power of the mobile station unit without dropping the ongoing communications to secure the noise immunity of the interference volume in the base station unit. As a result, the chances that an excessive interference volume disables decoding on the base station unit is reduced.

In the above mobile communications system, the transmission rate lowering means may lower the transmission rate of the signal transmitted from the mobile station unit below the transmission rate stored on the transmission rate storage means again when a predetermined time has elapsed in case the transmission rate recovery means recovers the transmission rate to the transmission rate stored on the transmission rate storage means.

In the above mobile communications system, the base station unit may comprise means for transmitting an instruction to the mobile station unit to elevate/lower the transmitting power of the mobile station unit in accordance with the receiving error rate of the signal transmitted from the mobile station unit and the mobile station unit may further comprise means for transmitting the signal at a power corresponding to the instruction transmitted from the base station unit. In general, the higher the transmission rate is, the higher the receiving error rate (index of errors in the received data such as a frame error rate, a block error rate and a bit error rate) becomes. By using the above approach, it is possible to elevate/lower the transmitting power of a mobile station unit by elevating/lowering the transmission rate. Thus, it is possible to secure the noise immunity of the interference volume in a base station unit by elevating/lowering the transmission rate in a mobile station unit.

A mobile communications system according to another aspect of the invention is a mobile communications system conforming to the CDMA Standard comprising a base station unit and a mobile station unit, wherein the mobile station unit comprises information code transmitting means for transmitting an information code to the base station unit and the base station unit comprises information code receiving means for receiving the information code transmitted from the base station unit and low rate transmission instruction transmitting means for transmitting a low rate transmission instruction to the mobile station unit, and the mobile station unit further comprises low rate transmission instruction receiving means for receiving the low rate transmission instruction and transmission rate change means for changing the transmission rate so as to lower the transmission rate of the information code transmitted by the information code transmitting means in accordance with the low rate transmission instruction.

According to the invention, when a base station unit lowers the transmission rate of a mobile station unit, the mobile station unit can lower its transmitting power. This lowers the transmitting power of the mobile station unit, thereby preventing a situation where the interference volume in the base station unit becomes suddenly excessive thus disabling decoding.

In the above mobile communications system, the base station unit may further comprise transmission rate determination means for determining that the mobile station unit is transmitting the information code at a transmission rate exceeding a predetermined threshold, and the low rate transmission instruction transmitting means may transmit the low rate transmission instruction to the mobile station unit depending on whether the mobile station unit is transmitting the information code at a transmission rate exceeding a predetermined threshold. By doing so, it is possible to transmit a low rate transmission instruction depending on whether the mobile station unit is transmitting the information code at the transmission rate exceeding a predetermined threshold.

In the above mobile communications system, the base station unit may further comprise interference volume determination means for determining that the interference volume in the base station unit exceeds a predetermined threshold, and the low rate transmission instruction transmitting means may transmit the low rate transmission instruction depending on whether the interference volume in the base station unit exceeds the predetermined threshold. By doing so, it is possible to transmit a low rate transmission instruction depending on the interference volume in the base station unit.

In the above mobile communications system, the mobile station unit may further comprise transmission rate storage means for storing the transmission rate before change in the transmission rate in case the transmission rate change means has changed the transmission rate and transmission rate recovery means for recovering the transmission rate of the mobile station unit to a transmission rate according to the transmission rate stored on the transmission rate storage means when a predetermined time has elapsed since the transmission rate was changed by the transmission rate change means. By doing so, it is possible to enhance the throughput of a mobile station unit.

In the above mobile communications system, the mobile station unit may further comprise predetermined time acquisition means for acquiring the predetermined time. By doing so, it is possible to acquire a time until the pre-change transmission rate is recovered.

In the above mobile communications system, the base station unit may further comprise predetermined time determination means for determining the predetermined time and predetermined time transmission means for transmitting the predetermined time determined to the mobile station unit, and the mobile station unit may further comprise predetermined time reception means for receiving the predetermined time, and the predetermined time acquisition means acquires the predetermined time by receiving the transmitted predetermined time. By doing so, the base station unit can determined a time until the pre-change transmission rate is recovered.

In the above mobile communications system, the base station unit may comprise means for transmitting an instruction to the mobile station unit to elevate/lower the transmitting power of the mobile station unit in accordance with the receiving error rate of the information code transmitted from the mobile station unit and the information code transmitting means transmits the information code at a power corresponding to the instruction transmitted from the base station unit. In general, the higher the transmission rate is, the higher the receiving error rate (index of errors in the received data such as a frame error rate, a block error rate and a bit error rate) becomes. By using the above approach, it is possible to elevate/lower the transmitting power of a mobile station unit by elevating/lowering the transmission rate. Thus, it is possible to secure the noise immunity of the interference volume in a base station unit by elevating/lowering the transmission rate in a mobile station unit.

A mobile station unit according to another aspect of the invention is a mobile station unit used in a mobile communications system conforming to the CDMA Standard, wherein the mobile station unit comprises transmission rate storage means for storing the transmission rate of a signal transmitted from the mobile station unit, transmission rate lowering means for lowering the transmission rate of the signal transmitted from the mobile station unit below the transmission rate stored on the transmission rate storage means, and transmission rate recovery means for recovering the transmission rate of the signal transmitted from the mobile station unit to the transmission rate stored on the transmission rate storage means when a predetermined time has elapsed in case the transmission rate lowering means lowers the transmission rate of the signal transmitted from the mobile station unit below the transmission rate stored on the transmission rate storage means.

A mobile station unit according to another aspect of the invention is a mobile station unit used in a mobile communications system conforming to the CDMA Standard, wherein the mobile station unit comprises information code transmission means for transmitting an information code to a base station unit, low rate transmission instruction receiving means for receiving the a low rate transmission instruction from the base station unit, transmission rate change means for changing the transmission rate of the information code in accordance with the low rate transmission instruction, transmission rate storage means for storing a transmission rate before change in the transmission rate in case the transmission rate change means has changed the transmission rate and transmission rate recovery means for recovering the transmission rate to a transmission rate according to the transmission rate stored on the transmission rate storage means when a predetermined time has elapsed since the transmission rate was changed.

A base station unit according to another aspect of the invention is a base station unit used in a mobile communications system conforming to the CDMA Standard, wherein the base station unit comprises information code reception means for receiving an information code transmitted from a mobile station unit, determination means for determining that the mobile station unit is transmitting the information code at a transmission rate exceeding a predetermined threshold, and low rate transmission instruction transmitting means for transmitting a low rate transmission instruction to the mobile station unit transmitting the information code at the transmission rate exceeding the predetermined threshold.

A transmission rate control method according to another aspect of the invention is a method for controlling the transmission rate of a mobile station unit used in a mobile communications system conforming to the CDMA Standard, wherein the method comprises a step of storing the transmission rate of a signal transmitted from the mobile station unit onto storage means, a step of lowering the transmission rate of the signal transmitted from the mobile station unit below the transmission rate stored on the transmission rate storage means, and a step of recovering the transmission rate of the signal transmitted from the mobile station unit to the transmission rate stored on the transmission rate storage means when a predetermined time has elapsed in case the transmission rate of the signal transmitted from the mobile station unit is lowered below the transmission rate stored on the transmission rate storage means.

A transmission rate control method according to still another aspect of the invention is a method for controlling the transmission rate of a mobile station unit used in a mobile communications system conforming to the CDMA Standard, wherein the method comprises a step of receiving an information code transmitted from a mobile station unit, a step of determining that the mobile station unit is transmitting the information code at a transmission rate exceeding a predetermined threshold, and a step of transmitting a low rate transmission instruction to the mobile station unit transmitting the information code at the transmission rate exceeding the predetermined threshold.

### BRIEF DESCRIPTION OF THE DRAWINGS

FIG. 1 is a block diagram of a mobile communications system according to an embodiment of the invention;

FIG. 2 is a block diagram of a mobile station unit according to an embodiment of the invention;

FIG. 3 is a block diagram of a base station unit according to an embodiment of the invention;

FIG. 4 is a functional block diagram of a mobile communications system according to an embodiment of the invention;

FIG. 5 is a flowchart of a transmission rate control processing according to an embodiment of the invention;

FIG. 6 explains the correspondence between a code S and a transmission rate according to an embodiment of the invention;

FIG. 7 is a flowchart of transmission rate fluctuation processing according to an embodiment of the invention;

FIG. 8 explains a common control channel according to an embodiment of the invention;

FIG. 9 explains the relationship between a transmission rate and a time according to an embodiment of the invention;

FIG. 10 is a functional block diagram of a mobile communications system according to an embodiment of the invention;

FIG. 11 is a functional block diagram of a mobile communications system according to an embodiment of the invention;

FIG. 12 is a flowchart of processing according to an embodiment of the invention; and

FIG. 13 is a flowchart of processing according to an embodiment of the invention.

### DESCRIPTION OF THE PREFERRED EMBODIMENTS

### Embodiment 1

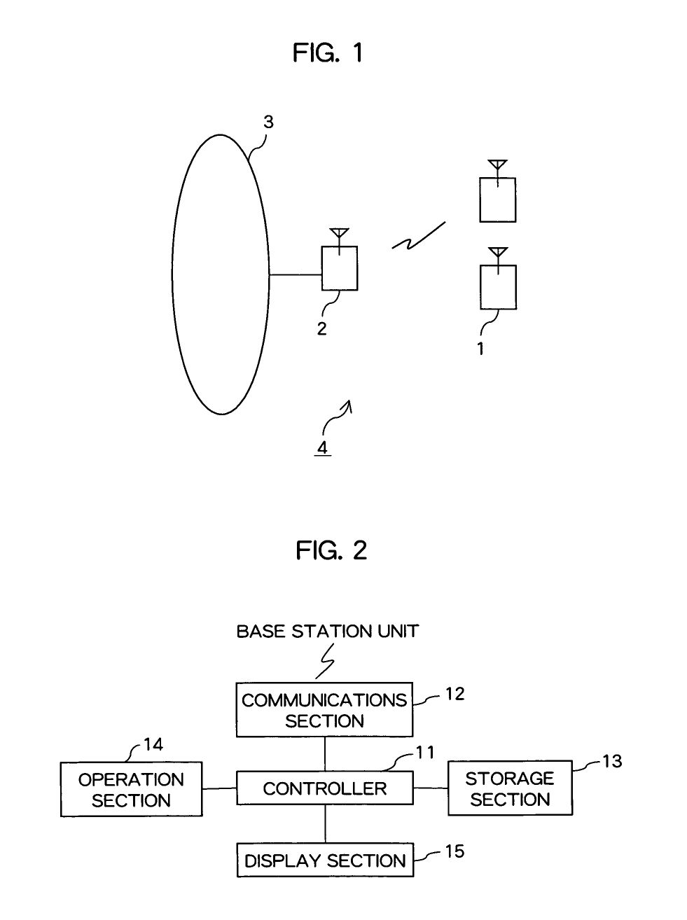

Embodiment 1 of the invention is described below referring to drawings. As shown in FIG. 1, a mobile communications system 4 comprises a plurality of mobile station units 1, a base station unit 2 and a communications network 3. The base station unit 2 typically communicates with a plurality of mobile station units 1 respectively by way of the CDMA system.

As shown in FIG. 2, the mobile station unit 1 comprises a controller 11, a communications section 12, a storage section 13, an operation section 14, and a display section 15. The controller 11 controls each section of the mobile station unit 1 and executes processing related to voice calls or data communications. When transmitting a communications packet used in data communications via the communications section 12, the controller 11 also performs processing to determine its transmission rate. The communications section 12 comprises an antenna and performs processing such as modulating a sound signal or a communications packet and outputting the resulting signal or packet via the antenna in accordance with an instruction input from the controller 11, and demodulating a sound signal or a communications packet arriving at the antenna and outputting the demodulated signal or packet to the controller 11.

The storage section 13 operates as a work memory for the controller 11. The storage section 13 holds programs and parameters related to various processing performed by the controller 11. The operation section 14 which is a ten-key pad e.g. receives an input of a directory number or a character string from the user and outputs the data to the controller 11. The display section 15 which is a liquid crystal display e.g. displays information in accordance with a signal input from the controller 11.

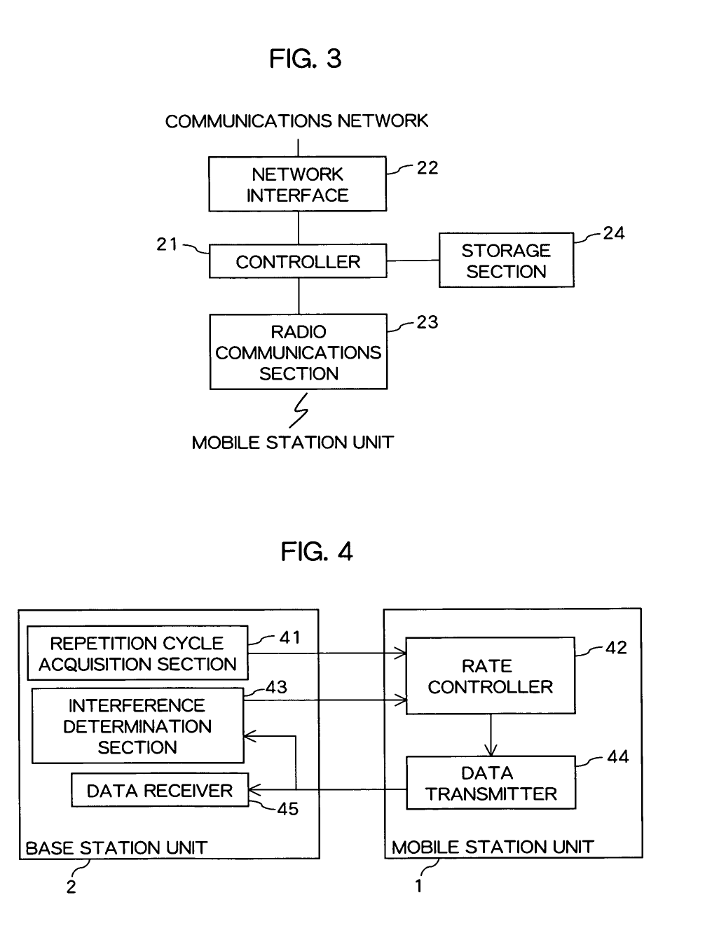

As shown in FIG. 3, the base station unit 2 comprises a controller 21, a network interface 22, a radio communications section 23, and a storage section 24. The controller 21 controls each section of the base station unit 2 and executes processing related to voice calls or data communications. The network interface 22 is connected to the communications network 3 and receives a sound signal or a communications packet from the communications network 3 and outputting the sound signal or communications packet to the controller 21, or transmits a sound signal or a communications packet to the communications network 3 according to an instruction of the controller 21. The radio communications section 23 comprises an antenna and performs processing such as receiving a sound signal or a communications packet from at least one mobile station unit 1, demodulating the sound signal or the communications packet, and outputting the demodulated signal or packet to the controller 21, or modulating a sound signal or a communications packet input from the controller 21 and outputting the modulated signal or packet via the antenna in accordance with an instruction input from the controller 21. The storage section 24 operates as a work memory for the controller 21. The storage section 24 holds programs and parameters related to various processing performed by the controller 21.

In case the base station unit 2 communications with the mobile station unit 1 by using the radio communications section 23, a traffic channel and a control channel can be used as logical channels. The traffic channel comprises an upstream communications channel and a downstream communications channel as well as a power control channel. A sound signal or a communications packet is communicated over the upstream/downstream communications channel. The upstream direction means communications from the mobile station unit 1 to the base station unit 2, while the downstream direction means communications from the base station unit 2 to the mobile station unit 1. The power control channel is used by the base station unit 2 to control the antenna power of the mobile station unit 1. The control channel includes a n upstream access channel, a downstream pilot channel, a synchronization channel and a paging channel. The access channel is used to transmit a signal from the mobile station unit 1 to the base station unit 2 and includes an upstream individual control channel. The pilot channel and the synchronization channel are those used to synchronize the base station unit 2 and the mobile station unit 1. The paging channel is used by the base station unit 2 to transmit control information on the mobile station unit 1 to the mobile station unit 1 and includes a common control channel for broadcasting to all communicable mobile station units 1 and a downstream individual control channel to communicate with individual mobile station units 1. In the common control channel, in particular, information indicating the interference volume or originating restriction is broadcasted to all communicable mobile station units. In the individual control channel, various signals used for a communications sequence to control each mobile station unit are communicated.

Signals in the above logical channels bound for the mobile station unit 1 from the base station unit 2 are included in a physical downstream channel comprising radio carriers of CDMA, while signals bound for the base station unit 2 from the mobile station unit 1 are included in a physical upstream channel comprising radio carriers of CDMA.

A signal (information code) including information such as a packet undergoes primary modulation into a signal of ASK (Amplitude Shift Keying), FSK (Frequency Shift Keying), or PSK (Phase Shift Keying) on the sender unit. In this system, the frequency or multilevel (in case multilevel modulation is used) of the primary modulated wave are made variable so as to make the transmission rate variable.

The primary modulated wave which has undergone the primary modulation is converted to a secondary modulated wave which is a product of the primary modulated wave and a waveform where for example −1 and +1 appear at random, a so-called PN (Pseudorandom Noise) series, which waveform is represented by a function with extremely high autocorrelation. The secondary modulated wave is superimposed on a carrier wave and the resulting wave is transmitted to a radio section. The process of obtaining a secondary modulated wave from a primary modulated wave is called diffusion. On the demodulator unit, by obtaining the product of the same PN series and the received secondary modulated wave, the original primary modulated wave is obtained. The process of obtaining a primary modulated wave from a secondary modulated wave is called reverse diffusion. By doing so, even in the presence of an interference wave during communications, the interference wave cannot undergo reverse diffusion despite a process to obtain the product of the wave and the PN series, but is further diffused. This provides an advantage that demodulation is more likely to occur even in the presence of an interference wave.

By using different PN series between mobile station units 1, a signal used to communicate with individual mobile station unit 1 is identified. Thus, in case a large number of mobile station units 1 are present and each mobile station unit 1 transmits a signal in accordance with the above system, each signal acts as an interference wave for other signals. In case the interference waves are numerous, the influence of interference waves is not negligible when reverse diffusion takes place. When the volume of interference waves exceeds a threshold, it is no longer possible to obtain a primary modulated wave due to reverse diffusion. In other words, a new call or a new information code cannot be demodulated and accepted on the base station unit 2. The volume of the interference wave is generally called the interference volume and typically represented by a signal-to-noise ratio (S/N ratio) or a carrier-to-noise ratio (C/N ratio). The interference volume can be calculated per mobile station unit 1. The total interference volume as a base station unit 2 may be a statistic value thereof. To be more precise, the interference volume may be the sum of interference volume per mobile station unit 1 or an average thereof.

Next, a packet used in communications between the mobile station unit 1 and the base station unit 2 is transmitted at a transmission rate of multiple stages. For example, a packet used in CDMA2000 is typically transmitted at one of the transmission rates of five stages. To be more precise, the rate is determined as one of the rates of 9.6 kbps, 19.2 kbps, 38.4 kbps, 76.8 kbps, and 153.6 kbps. The base station unit 2 and the mobile station unit 1 communicate with each other at one of these transmission rates.

The base station unit 2 performs so-called closed loop control. The base station unit 2 monitors the SIR (receiving SIR) of a signal received from the mobile station unit 1 and in case the SIR is equal to or above a given target SIR, instructs the mobile station unit 1 to reduce the transmitting power. In case the SIR is below the given target SIR, the base station unit 2 instructs the mobile station unit 1 to increase the transmitting power. Here, SIR is Signal to Interference Ratio. In this practice, the target SIR is determined by a receiving error rate such as an FER (Frame Error Rate). For example, in case the receiving error rate is greater than a predetermined value, the target SIR is increased. In case the receiving error rate is smaller than a predetermined value, the target SIR is decreased.

In the mobile communications system 4, the base station unit 2 employs the closed loop control described above. Thus, the transmission rate of the mobile station unit 1 is correlated with the transmitting power of the mobile station unit 1. When the mobile station unit 1 performs data communications at a low rate, the base station unit 2 enjoys an improved quality of a received signal from the mobile station unit 1 and the target SIR drops accordingly. As a result, the base station unit 2 is more likely to issue an instruction to decrease the transmitting power to the mobile station unit 1. When the mobile station unit 1 performs data communications at a high rate, the base station unit 2 receives a signal of a degraded quality from the mobile station unit 1 and the target SIR increases accordingly. As a result, the base station unit 2 is more likely to issue an instruction to increase the transmitting power to the mobile station unit 1.

In this way, the mobile communications system 4 elevates/lowers the transmission rate of the mobile station unit 1 to indirectly elevate/lower the transmitting power of the mobile station unit 1.

FIG. 4 is a function block diagram of a mobile station unit 1 and a base station unit 2 used in this embodiment. As shown in FIG. 4, the mobile station unit 1 comprises, from a functional point of view, a rate controller 42 and a data transmitter 44. The base station unit 2, comprises, from a functional point of view, a repetition cycle acquisition section 41, an interference determination section 43 and data receiver 45. The repetition cycle acquisition section 41 notifies the mobile station unit 1 of the cycle of elevating/lowering the transmission rate mentioned below by using the individual control channel. The repetition cycle may be transmitted each time transmission rate is controlled by the mobile station unit 1, or transmitted to the mobile station unit 1 prior to communications. The same repetition cycle may be broadcast to all mobile station units 1 over the common control channel. In this practice, in case all mobile station units 1 lower respective transmission rates, it is possible to reduce the chances that the interference volume becomes excessive thus disabling decoding. In case all mobile station units 1 elevate respective transmission rates, there exist more chances that the interference volume becomes excessive thus disabling decoding. It is therefore desirable to use different timings at the mobile station units 1.

The interference determination section 43 measures the interference volume in an upstream channel. To be more specific, the interference volume may be measured based on the ratio of a signal received in an upstream channel to the corresponding noise or the ratio of the carrier power in an upstream channel to the corresponding noise power. A value which represents the range of an interference volume is transmitted to the mobile station unit 1 over the common control channel. The interference volume may be a value concerning each mobile station unit 1 or a statistic volume such as an average of all or some interference volumes.

The rate controller 42 receives a repetition cycle transmitted by the repetition cycle acquisition section 41 and a value indicating the range of an interference volume transmitted by the interference determination section 43. The rate controller 42 determines the transmission rate obtained based on a predetermined range the interference volume belongs to and the repetition cycle as a transmission rate at which a packet is transmitted, and passes the transmission rate to the data transmitter 44. The data transmitter 44 uses an upstream data channel to transmit a packet at the received transmission rate. The data receiver 45 receives the packet transmitted from the data transmitter 44 of at least one mobile station unit 1 and performs processing such as decoding. The interference determination section 43 measures the interference volume in the upstream channel from the ratio of a signal including the packet to the noise and repeats the above processing.

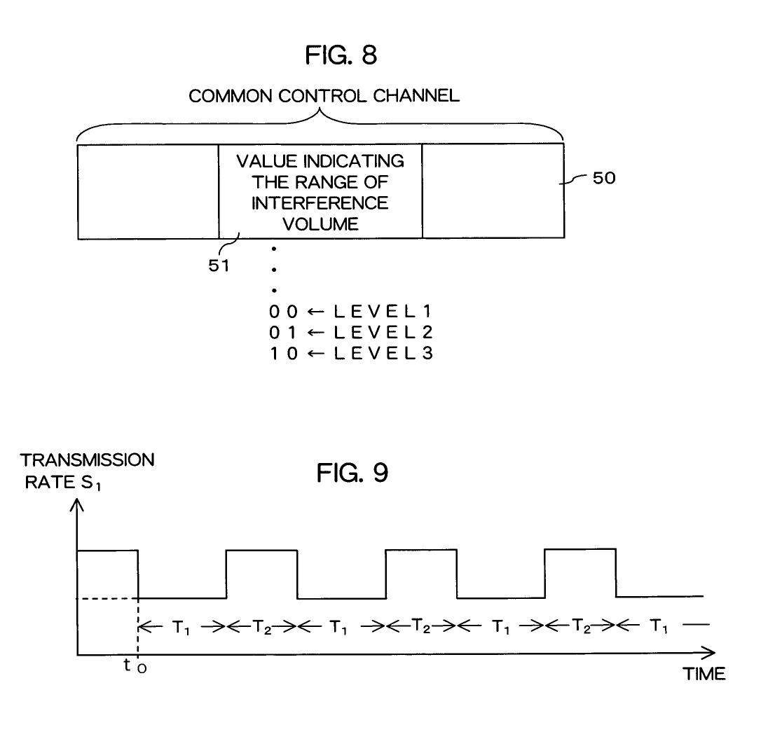

This embodiment is described below in more detail. The repetition cycle is transmitted to the mobile station unit 1 over an individual control channel prior to communications. The repetition cycle includes a low rate time T₁ and a recovery rate time T₂ respectively corresponding to a period when the transmission rate is low and a period when the transmission rate is high (at the original transmission rate). The interference determination section 43 determines which range the current interference volume belongs to in case the interference volume in the upstream channel is divided into three stages, LEVEL 1 through LEVEL 3. The interference determination section 43 transmits a value indicating the range over the common control channel. To be more specific, as shown in FIG. 8, the value may be included as 2-bit information 51 in the common control channel 50. In this example, LEVEL 1 shows the minimum interference volume. LEVEL 2 shows an increased interference volume than LEVEL 1. LEVEL 3 shows the maximum interference volume. The rate controller 42 of the mobile station unit 1 receives a value indicating which range the transmitted interference volume belongs to and accordingly changes the processing to determine the transmission rate. That is, in case the interference volume belongs to LEVEL 1, the transmission rate is increased at a predetermined probability in accordance with random numbers (and the transmitting power is also increased) to enhance the throughput of each mobile station unit 1. In case the interference volume belongs to LEVEL 3, the transmission rate is decreased at a predetermined probability in accordance with random numbers (and the transmitting power is also decreased) to lower the interference volume. In case interference volume belongs to LEVEL 2, in order to avoid a situation where closed loop control is not made to lower the transmission rate with the right timing, such as in a case where a large number of new information codes are transmitted at a time, and the interference volume becomes LEVEL 3, thus resulting in excessive interference volume disabling decoding on the base station unit 2, a period is provided where the transmission rate is lowered (a period where the transmitting power is lowered) by the principle of give-and-take between mobile station units 1 beforehand. To recover the throughput which has dropped because the transmission rate is lowered, the original transmission rate is recovered after a predetermined period (the original transmitting power is recovered). In this way, the throughput is maintained. By cyclically elevating/lowering the transmission rate, it is possible to more effectively reduce the probability of decoding being disabled on the base station unit 2. The cycle is the repletion cycle transmitted from the repetition cycle acquisition section 41.

Amore specific example of the processing in the rate controller 42 is described below.

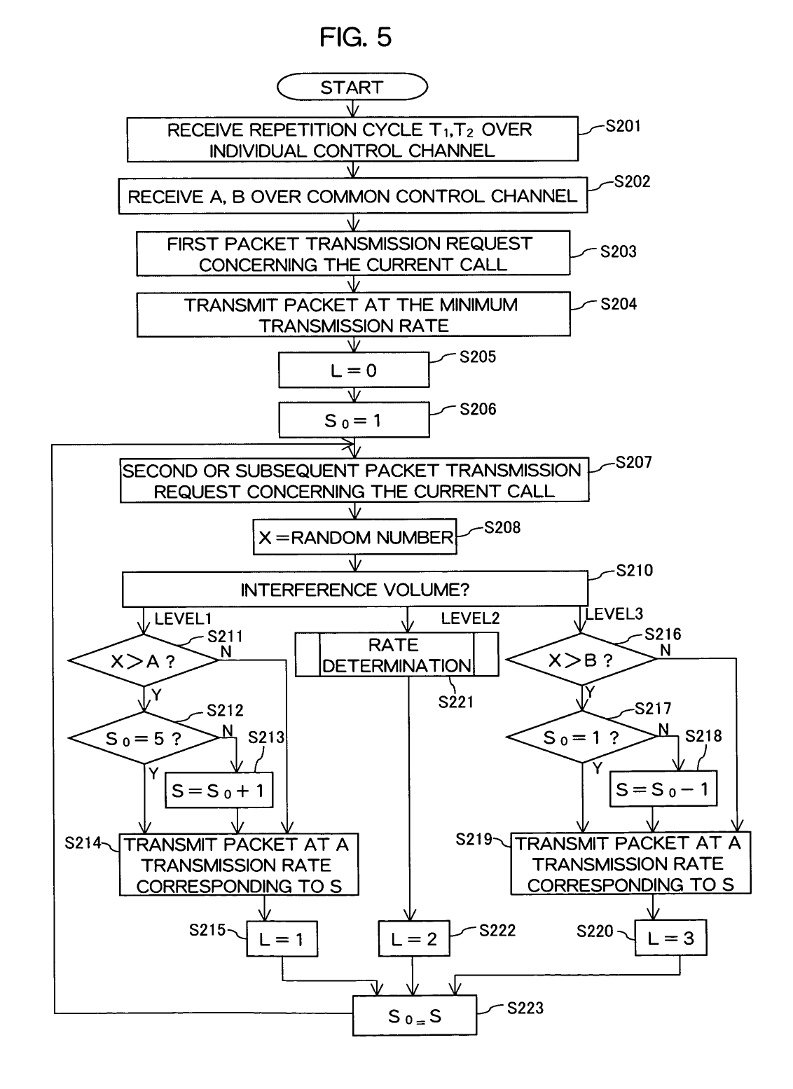

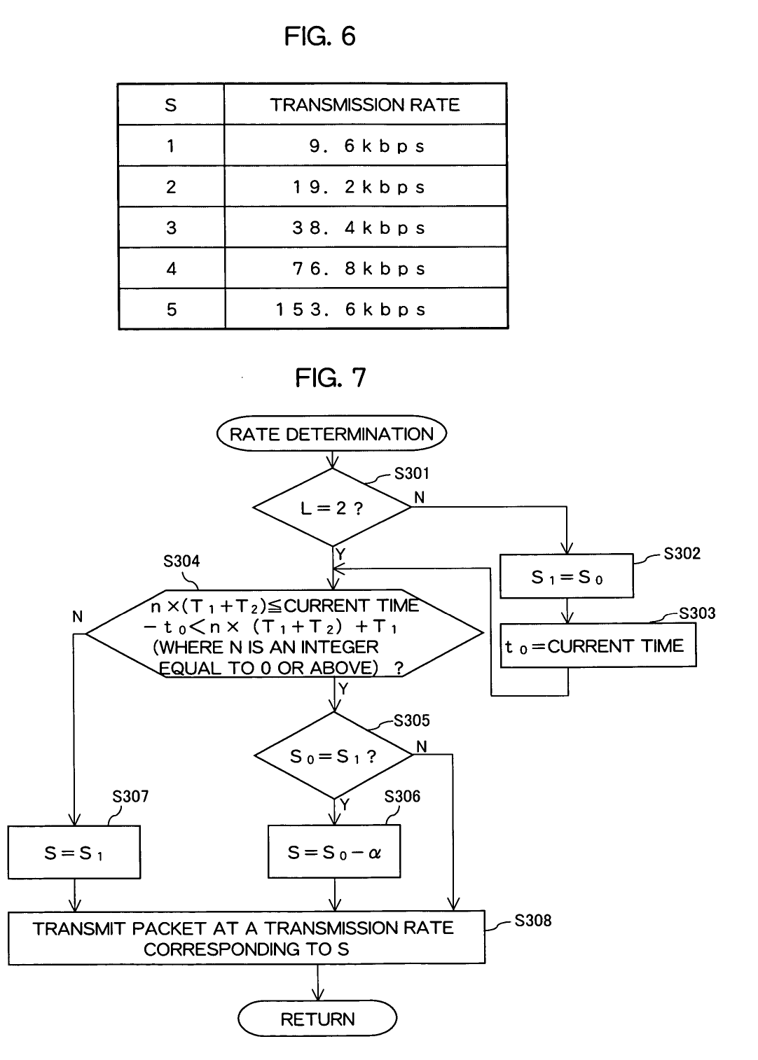

FIG. 5 is a flowchart of the processing to determine the transmission rate of a packet in accordance with a predetermined range the interference volume belongs to in the rate controller 42. The code S in FIG. 5 corresponds to a transmission rate, the details of which are shown in FIG. 6. FIG. 6 shows a table stored on the storage section 13. As shown in FIG. 6, the greater the numerical value of the code S as a numerical value to identify the transmission rate is, the higher transmission rate is associated. The low rate time T₁ and the recovery rate time T₂ are received from the base station unit 2 over the common control channel (S201). Two values, A and B, are received from the base station unit 2 over the common control channel (S202). As mentioned later, A and B are constants used to determine the transmission rate of a packet and are thresholds to determine the transmission rate of a packet in accordance of the values of random numbers. Typically, A>B is satisfied. A corresponds to the probability of elevating the transmission rate in the presence of a low interference volume while B corresponds to the probability of lowering the transmission rate in the presence of a high interference volume. In case an upstream data transmission request is issued by the mobile station unit 1 (S203), a packet is transmitted at the minimum transmission rate (S204). This is to reduce the influence of the interference volume in the base station unit 2 as far as possible. An area to store a variable L is reserved and 0 is substituted for L (S205). L is a variable used to store the level of the interference volume in a later procedure. An area to store a variable S₀ is reserved and 1 is substituted for S₀ (S206). S₀ is a variable used to store the record to transmission rates in a later procedure.

In case an upstream data transmission request takes place (S207), a random number X is generated (S208). X is a random number used to prevent the influence on the interference volume due to concurrent variations in the transmission rate of a large number of mobile station units 1. It is determined which of LEVEL 1 through LEVEL 3 the interference volume of the base station unit 2 belongs to (S210). In case the interference volume belongs to LEVEL 1, whether X>A is determined (S211). In case X>A, a packet is transmitted at a transmission rate one-level higher than the transmission rate S₀ of the just transmitted packet (S213, S214). In case S₀ is already the maximum transmission rate, a packet is transmitted without elevating the transmission rate (S212, S214) In case X>A is not satisfied, a packet is transmitted at S₀ (S214) 1 is substituted for the variable (S215), followed by the processing of step S223 mentioned later. In case the interference volume belongs to LEVEL 3, it is determined whether X>B (S216). In case X>B, a packet is transmitted at a transmission rate one-level lower than the transmission rate S₀ of the just transmitted packet (S218, S219). In case S₀ is already the minimum transmission rate, a packet is transmitted without lowering the transmission rate (S217, S219). In case X>B is not satisfied, a packet is transmitted at S₀ (S219). 3 is substituted for the variable L (S220), followed by the processing of step S223 mentioned later.

In case the interference volume belongs to LEVEL 2, the rate determination processing shown in FIG. 7 is performed (S221). In the processing shown in FIG. 7, it is determined whether L=2 (S301) This is made since it is necessary to store the transmission rate in case the interference volume last time was not one which required rate determination processing. Unless L=2, S₀ is substituted for a variable S₁ (S302). S₁ is a reference transmission rate for transmission rate repetition in a mobile station unit 1. The current time is substituted for a variable to (S303). t₀ is a reference for repetition cycle.

Next, specific repletion processing is performed, where repetition of a transmission rate shown in FIG. 9 is made. In FIG. 9, the transmission rate S1 is lowered at to as a reference and is maintained for the period of T₁, then the original transmission rate is recovered. S1 is maintained for the period of T₂, then the transmission rate is lowered again. This processing is repeated while the interference volume belongs to LEVEL 2. This specific processing is shown in FIG. 7. In step S304 in FIG. 7, it is determined whether the current time satisfies the expression (1) below. In case the formula (1) is satisfied, the current time falls within the section T₁ shown in FIG. 9.

(Formula 1)
n×(T₁+T₂)<current time−t₀<n×(T₁+T₂)+T₁ (1)
where n is an integer equal to 0 or above. In case the above formula (1) is satisfied, that is, in case the current time falls within the period when the transmission rate is lowered (transmitting power is lowered), it is determined whether S₀ is equal to S₁, that is, the transmission last time used the reference transmission rate (S305). In case S₀ is equal to S₁, S is lowered by α from S₀ and a packet is transmitted at a transmission rate corresponding to the S (S306, S308). α is an integer from 0 to 4 inclusive and S is lowered from S₀ within the range of 1 to 4. α can be randomly selected. In case S₀ is not equal to S1, S₀ is not substituted for S and a packet is transmitted at a transmission rate corresponding to S (S308). That is, the lowered transmission rate is maintained. Next, in case the formula (1) is not satisfied, that is, in case the current time falls within the period when the reference transmission rate is used (transmitting power is recovered), S₁ is substituted for s (S307) and a packet is transmitted at a transmission rate corresponding to S (S308). Execution returns to the processing in FIG. 5. In step S222 in FIG. 5, 2 is substituted for L and S for S₀ (S223), then execution returns to step S207. S is substituted for S₀ so as to store the transmission rate last time.

By doing so, in this embodiment, on top of the general transmitting power control by way of closed loop control, a period is provided when the transmission rate is temporarily lowered in a forcible fashion in order to lower the transmitting power, it is possible to secure the noise immunity of the interference volume. It is thus possible to avoid a situation where closed loop control is not made with the right timing, such as in a case where a large number of new information codes are transmitted at a time, thus resulting in excessive interference volume disabling decoding on a base station unit 2.

The transmission rate is elevated or lowered repeatedly, not just lowered. This prevents a drop in the throughput of each mobile station unit 1. The range of the repetition cycle and interference volume can be arbitrary set by using office data. It is thus possible to determine a proper range depending on the circumstances of an individual base station unit 2 including the location of the base station unit 2 and time zones.

By applying the low rate period T₁ with a separate timing per mobile station unit 1, it is possible to steadily provide the noise immunity of the interference volume in the base station unit 2 while reducing the load on the mobile station unit 1. The base station unit 2 determines which range the interference volume belongs to. Thus, a value indicating which range the interference volume transmitted over the common control channel belongs to occupies at most 2 bits. This effectively exploits the limited radio resources and skips the calculation process in each mobile station unit 1, which reduces the processing load of the mobile station unit 1.

### Embodiment 2

Embodiment 2 of the invention is described below referring to drawings. Configuration of a mobile communications system 4 according to this embodiment is basically the same as that shown in FIGS. 1 through 3 of Embodiment 1, except that some functions are different. In Embodiment 1, the mobile station unit 1 autonomously changes the transmission rate as required to change the transmitting power of the mobile station unit 1. In Embodiment 2, the transmission rate of the mobile station unit 1 is changed based on an instruction from the base station unit 2 in order to change the transmitting power of the mobile station unit 1.

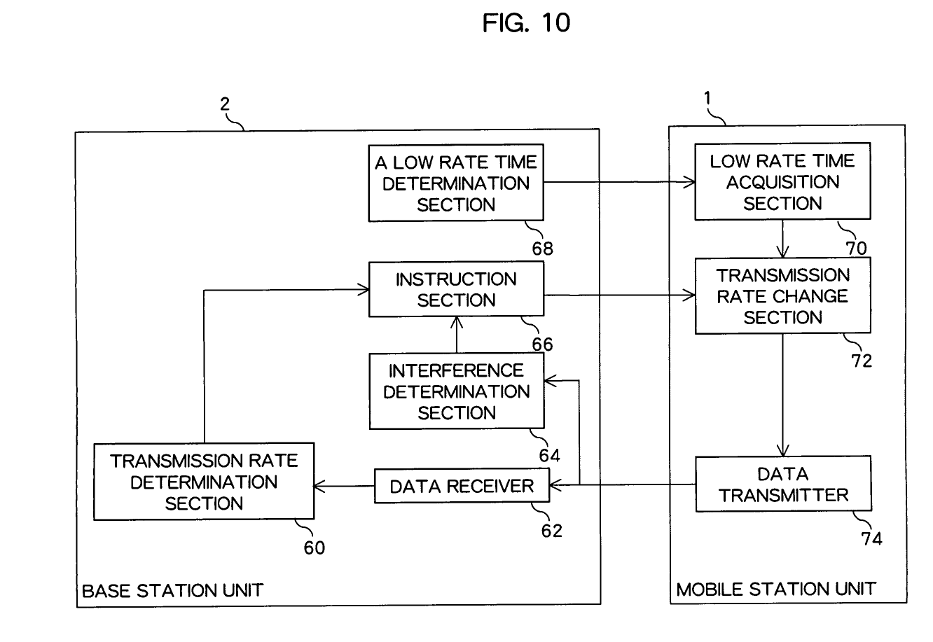

FIG. 10 is a functional block diagram of a mobile station unit 1 and a base station unit 2 used in this embodiment. As shown in FIG. 10, the base station unit 2 comprises, from a functional point of view, a transmission rate determination section 60, a data receiver 62, an interference determination section 64, an instruction section 66 and a low rate time determination section 68. The mobile station unit 1 comprises, from a functional point of view, a low rate time acquisition section 70, a transmission rate change section 72 and a data transmitter 74.

The data transmitter 74 transmits an information code using for example an upstream communications channel. When the information code is transmitted, the transmission rate of the information code is selected from among the previously stored transmission rates of multiple stages. For example, in case the information code is a packet in the CDMA2000 environment, one of the transmission rates of 9.6 kbps, 19.2 kbps, 38.4 kbps, 76.8 kbps, and 153.6 kbps is selected and the packet is transmitted at the selected transmission rate. Same as Embodiment 1, in the mobile communications system 4, the transmission rate is elevated/lowered in the mobile station unit 1 in order to indirectly elevate/lower the transmitting power of the mobile station unit 1.

The data receiver 62 receives an information code transmitted by the data transmitter 74. The information code is for example a packet included in an upstream channel. The data transmitter 74 outputs the transmission rate of a packet to be received to the transmission rate determination section 60.

The transmission rate determination section 60 determines whether the above input transmission rate exceeds a predetermined threshold. For example, assuming a predetermined threshold of 150 kbps in the CDMA2000 environment, a transmission rate of 153.6 kbps is determined to exceed the predetermined threshold. The transmission rate determination section 60 outputs the result of determination to the instruction section 66. It is possible to determine whether the above input transmission rate exceeds a predetermined threshold for a predetermined time. That is, in case the above transmission rate exceeds a predetermined threshold at a point in time, counting is started and in case the transmission rate exceeds the predetermined threshold until a predetermined time is reached, it may be determined that the transmission rate has exceeded a predetermined threshold for a predetermined time.

The interference determination section 64 determines whether the interference volume in the upstream channel exceeds a predetermined threshold. To be more precise, as mentioned earlier, the interference volume is represented for example by the S/N ratio. It is determined whether the S/N ratio exceeds a predetermined threshold and the result of determination is output to the instruction section 66.

The instruction section 66 transmits a low rate transmission instruction to the mobile station unit 1 depending on the result of determination input from the transmission rate determination section 60 and the result of determination input from the interference determination section 64. Transmission may be made depending on either result. Or, transmission may be made without considering these results. In case the result of determination input from the transmission rate determination section 60 is considered, a low rate transmission instruction is preferably transmitted when the result of determination that a predetermined threshold is exceeded; otherwise transmission is preferably limited. By doing so, it is possible to lower the transmission rate of the mobile station unit 1 engaged in transmission above a predetermined threshold. As mentioned above, the mobile station unit 1 with a high transmission rate has a high antenna power related to transmission and has a great influence on the interference volume. The above approach reduces the chances that decoding is disabled on a base station unit 2. In case the result of determination input from the interference determination section 64 is considered, a low rate transmission instruction is preferably transmitted when the result of determination that a predetermined threshold is exceeded; otherwise transmission is preferably limited. By doing so, it is possible to lower the transmission rate of the mobile station unit 1 in case the interference volume is actually large. This reduces the influence on the interference volume caused by the upstream channel from the mobile station unit 1, thereby reducing the chances that decoding is disabled on a base station unit 2. The low rate transmission instruction is preferably transmitted to the mobile station unit 1 by using the individual downstream control channel. The low rate transmission instruction may be made by specifying 0 or 1 to a single bit in the downstream control channel. In this case, setting of 0 means an instruction to the mobile station unit 1 to keep the current transmission rate and setting of 1 means an instruction to the mobile station unit 1 to lower the current transmission rate. Or, a specific transmission rate may be specified in the low rate transmission instruction.

The mobile station unit 1 receives the low rate transmission instruction at the transmission rate change section 72. The transmission rate change section 72 changes the transmission rate of an information code transmitted by the data transmitter 74 in accordance with the low rate transmission instruction. The mobile station unit 1 need not necessarily follow the low rate transmission instruction. The mobile station unit 1 may change the transmission rate for other reasons. For example, in case a specific transmission rate of 76.8 kbps is specified in a low rate transmission instruction, the mobile station unit 1 may change the transmission rate to for example 38.4 kbps without restriction. This assumes a case where the power of a radio wave carried between the mobile station unit 1 and the base station unit 2 is degraded, resulting in a higher BER (Bit Error Rate) and the ongoing communications may be dropped unless the transmission rate is lowered to 38.4 kbps. In case the low rate transmission instruction is received, the transmission rate of an information code transmitted by the data transmitter 74 may be changed so as to reduce the chances that decoding is disabled on the base station unit 2.

Next, the low rate time determination section 68 determines the length of time when the mobile station unit 1 which has received the low rate transmission instruction uses a low rate. While the transmission rate change section 72 changes the transmission rate of an information code transmitted by the data transmitter 74 in accordance with the low rate transmission instruction, the original transmission rate may be recovered when a predetermined time has elapsed. For this purpose, the low rate time determination section 68 determines the predetermined time and transmits it to the low rate time acquisition section 70 in the mobile station unit 1. The predetermined time is preferably transmitted to the mobile station unit 1 by using the downstream individual control channel. The determination or transmission may be made at the same time with the low rate transmission instruction. The predetermined time may be transmitted with a timing that the mobile station unit 1 is in the service area of the base station unit 2. In case the transmission process is in common among the base station units 2, transmission may be made when the mobile station unit 1 is powered. In case the transmission process is in common among the mobile station units 1, the mobile station unit 1 may be notified using a common control channel. In case no changes are necessary, the transmission rate may be previously stored onto the storage section 13 in the manufacturing stage of the mobile station unit 1. In this case, the base station unit 2 need not determine nor transmit the transmission rate. The mobile station unit 1 may determine the transmission rate. In case a plurality of mobile station unit 1 have recovered the transmission rate at once, a sudden rise in the interference volume may take place. It is thus desirable to change the predetermined time between the mobile station units 1. To be more precise, the predetermined time may be determined based on random numbers.

The low rate time acquisition section 70 receives and acquires the predetermined time. The low rate time acquisition section 70 then outputs the predetermined time to the transmission rate change section 72. The transmission rate change section 72 may store the pre-change transmission rate as well as monitor the elapse of the predetermined time input from the low rate time acquisition section 70, in case it changes the transmission rate of an information code transmitted by the data transmitter 74 in accordance with the low rate transmission instruction. In case it is determined that the predetermined time has elapsed, the transmission rate change section 72 may return to the stored pre-change transmission rate.

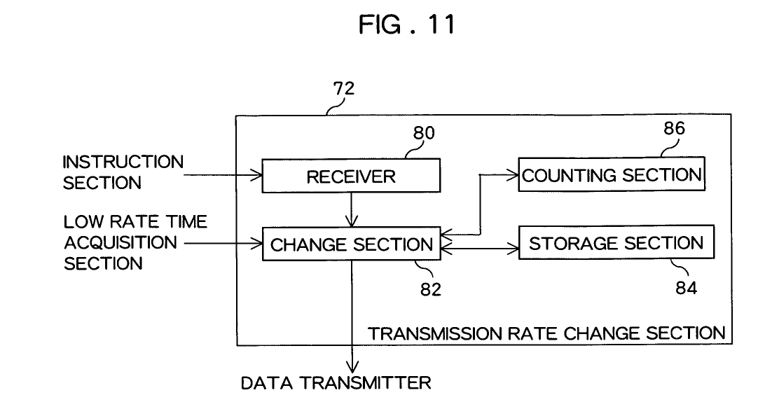

The processing in the transmission rate change section 72 will be detailed again. FIG. 11 is a function block diagram of the internal functions of the transmission rate change section 72. A receiver 80 receives a low rate transmission instruction from the instruction section 66 and outputs the low rate transmission instruction to a change section 82. The change section 82 changes the transmission rate of an information code in the data transmitter 74 in accordance with the low rate transmission instruction. The change section 82 stores the pre-change transmission rate onto a storage section 84. The change section 82 receives time information input from the low rate time acquisition section 70, and passes the time information to a counting section 86. The counting section 86 starts counting with the timing the change section 82 changes the transmission rate in the data transmitter 74. When the time indicated by the received time information is reached, the counting section 86 notifies the change section 82 of the arrival of the time. The change section 82 reads the pre-change transmission rate from the storage section 84 and returns the transmission rate in the data processor 74 to the transmission rate thus read.

The above processing will be described referring to specific flowcharts.

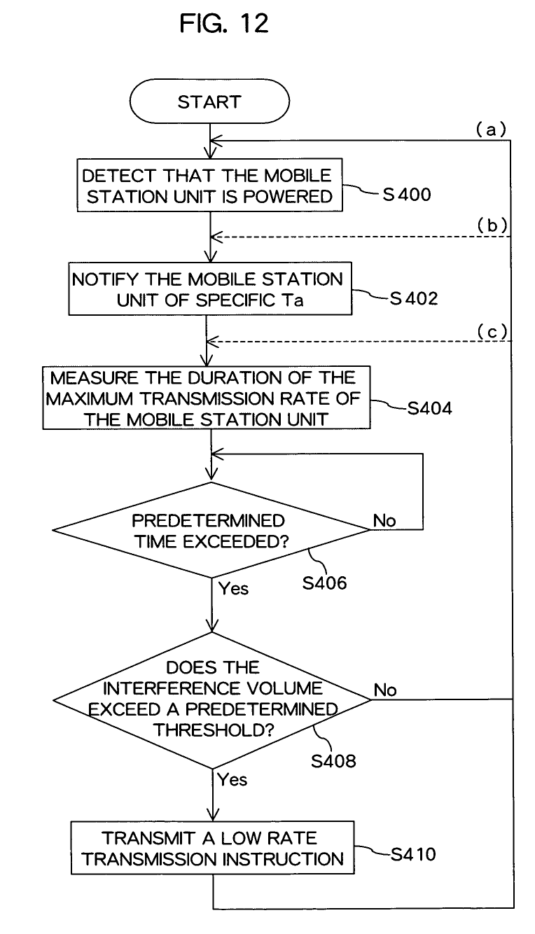

FIG. 12 is a flow chart showing the processing in the base station unit 2. In the processing shown in FIG. 12, the base station unit 2 detects that the mobile station unit 1 is powered (S400). To be more specific, detection is made by way of known location registration according to the related art. The mobile station unit 1 is notified of Ta specific to the mobile station unit 1 (S402). Ta is the length of time during which the mobile station unit 1 which has received a low rate transmission instruction determined by the low rate time determination section 68 lowers the transmission rate. Ta may be a numeral specific to each mobile station unit 1. The base station unit 2 determines that the mobile station unit 1 is transmitting an information code at the maximum transmission rate in CDMA2000 of 153.6 kbps and measures the time when transmission at the transmission rate is under way (S404). To be more specific, in case the base station unit 2 has detected that an information code is transmitted at a transmission rate of 153.6 kbps, counting starts from the point in time detection is made. The base station unit 2 determines whether the predetermined time is reached (S406). In case the predetermined time is reached, the base station unit 2 determines whether the interference volume exceeds a predetermined threshold (S408). In case the interference volume exceeds the predetermined threshold, the base station unit 2 transmits a low rate transmission instruction to the mobile station unit 1 (S410). In case the base station unit 2 had transmitted a low rate transmission instruction or in case the interference volume does not exceed the predetermined threshold, the base station unit 2 may determine that the mobile station unit 1 is transmitting an information code at the maximum transmission rate and measure the time during which transmission at the transmission rate is under way (c). The base station unit 2 may transmit a new Ta (b) or may wait until the mobile station unit 1 is powered again, without performing processing (a).

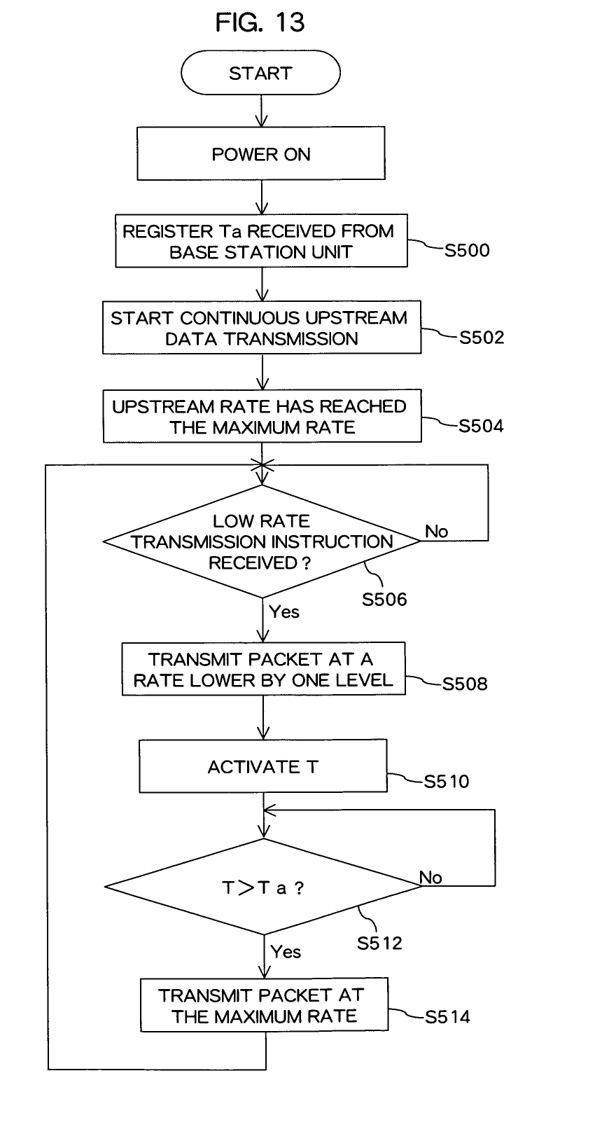

FIG. 13 shows the processing in the mobile station unit 1 corresponding to the base station unit 2 shown in FIG. 12. In the processing shown in FIG. 13, when the mobile station unit 1 is powered, the mobile station unit 1 receives Ta transmitted from the base station unit 2 by using a downstream individual control channel (S500). The mobile station unit 1 transmits an information code such as a packet for example by using an upstream communications channel (S502). For example, in CDMA2000, the mobile station unit 1 starts transmission at the minimum transmission rate of 9.6 kbps and gradually increases the transmission rate in accordance with the receiving level of a pilot signal transmitted from the base station unit 2 or information on the interference volume noticed from the base station unit 2. Thus, the transmission rate may reach the maximum transmission rate of 153.6 kbps (S504). As mentioned in the processing in the base station unit 2, in case transmission is under way at the maximum transmission rate, a low rate transmission instruction may be received from the base station unit 2 (S506). In case the low rate transmission instruction is received, the mobile station unit 1 changes the transmission rate to lower the current transmission rate by one level (S508). The mobile station unit 1 activates a timer. In case the timer has exceeded Ta, the mobile station unit 1 returns the transmission rate to the maximum transmission rate (S510, S512, S514). That is, the original transmission rate is recovered. In this way, the mobile station unit 1 elevates or lowers the transmission rate in accordance with an instruction from the base station unit 2, thereby reducing the chances that decoding is disabled on the base station unit 2. After the maximum transmission rate is reached in step S514, the mobile station unit 1 may wait for another low rate transmission instruction from the base station unit 2.

By changing the transmission rate, it is possible to indirectly change the transmitting power of the mobile station unit 1, thereby reducing the chances that decoding is disabled on the base station unit 2. In case transmission is under way at a transmission rate exceeding a predetermined threshold for a predetermined time, the base station unit 2 can issue a low rate transmission instruction and determine the time during which a low rate transmission is made. This allows the base station unit 2 to flexibly control the transmission rate. By transmitting a low rate transmission instruction in case the interference volume is large, the interference volume is decreased, which reduces the chances that decoding is disabled due to a large interference volume. The pre-change transmission rate may be recovered after a predetermined time, which enhances the throughput of the mobile station unit 1.

While there have been described what are at present considered to be preferred embodiments of the invention, it will be understood that various modifications may be made thereto, and it is intended that the appended claims cover all such modifications as fall within the true spirit and scope of the invention.

While the rate controller 42 resides in the mobile station unit 1 in Embodiment 1, it may reside in the base station unit 2. In this case, the transmission rate is transmitted from the base station unit 2 to the mobile station unit 1 using a downstream individual control channel. The repetition cycle may be calculated by the mobile station unit 1 or previously stored on the mobile station unit 1. The interference determination section 43 may transmit the interference volume itself to the mobile station unit 1. In case the interference determination section 43 transmits the interference volume itself to the mobile station unit 1, the rate controller 42 divides the interference volume into predetermined ranges and obtains values indicating the ranges. The number of stages may be other than 3. Other transmission rate control processing may be introduced. While the above embodiments pertain to a mobile communications system, the invention is applicable to a communications system of any form, as long as it is a communications system conforming to the CDMA Standard.

While a mobile communications system has been described as an example in the foregoing embodiments, the invention is applicable to any communications system where communications units communicate with each other. To be more specific, such a system may be a wireless or wired LAN (Local Area Network). Taking a wireless LAN as an example, the invention is applicable to the infrastructure mode where access points are provided as well as the ad hoc mode where communications units performs end-to-end communications without using access points.

Further, the disclosure of Japanese Patent Application Nos. 2004-55543 filed on Feb. 27, 2004 and 2004-108550 filed on Mar. 31, 2004, including specification, claims, drawings and abstract is incorporated herein by reference in its entirety.

1. A mobile communications system conforming to the Code Division Multiple Access (CDMA) Standard comprising a base station unit and a mobile station unit, wherein
said mobile station unit comprises
transmission rate storage means for storing a transmission rate of a signal transmitted from the mobile station unit,
transmission rate lowering means for lowering the transmission rate of the signal transmitted from the mobile station unit below said transmission rate stored on said transmission rate storage means and
transmission rate recovery means for recovering the transmission rate of the signal transmitted from the mobile station unit to said transmission rate stored on said transmission rate storage means when a predetermined time has elapsed in case said transmission rate lowering means lowers the transmission rate below said transmission rate stored on said transmission rate storage means.

2. The mobile communications system according to claim 1, wherein
said transmission rate lowering means lowers the transmission rate of the signal transmitted from the mobile station unit below said transmission rate stored on said transmission rate storage means again when a predetermined time has elapsed in case said transmission rate recovery means recovers the transmission rate to said transmission rate stored on said transmission rate storage means.

3. The mobile communications system according to claim 1, wherein
said base station unit comprises means for transmitting an instruction to the mobile station unit to elevate/lower the transmitting power of said mobile station unit in accordance with the receiving error rate of the signal transmitted from said mobile station unit and said mobile station unit further comprises means for transmitting the signal at a power corresponding to the instruction transmitted from said base station unit.

4. A mobile communications system conforming to the CDMA Standard comprising a base station unit and a mobile station unit, wherein said mobile station unit comprises
information code transmitting means for transmitting an information code to said base station unit, wherein said base station unit comprises
information code receiving means for receiving the information code transmitted from said base station unit and
low rate transmission instruction transmitting means for transmitting a low rate transmission instruction to said mobile station unit, and wherein
said mobile station unit further comprises
low rate transmission instruction receiving means for receiving said low rate transmission instruction and
transmission rate change means for changing the transmission rate so as to lower the transmission rate of the information code transmitted by said information code transmitting means in accordance with said low rate transmission instruction.

5. The mobile communications system according to claim 4, wherein
said base station unit further comprises
transmission rate determination means for determining that said mobile station unit is transmitting said information code at a transmission rate exceeding a predetermined threshold and wherein
said low rate transmission instruction transmitting means transmits said low rate transmission instruction to said mobile station unit depending on whether said mobile station unit is transmitting said information code at the transmission rate exceeding a predetermined threshold.

6. The mobile communications system according to claim 4, wherein
said base station unit further comprises
interference volume determination means for determining that the interference volume in said base station unit exceeds a predetermined threshold and wherein
said low rate transmission instruction transmitting means transmits said low rate transmission instruction depending on whether the interference volume in said base station unit exceeds the predetermined threshold.

7. The mobile communications system according to claim 4, wherein
said mobile station unit further comprises
transmission rate storage means for storing the transmission rate before change in the transmission rate in case said transmission rate change means has changed the transmission rate and
transmission rate recovery means for recovering the transmission rate of the mobile station unit to a transmission rate according to said transmission rate stored on said transmission rate storage means when a predetermined time has elapsed since the transmission rate was changed by said transmission rate change means.

8. The mobile communications system according to claim 7, wherein
said mobile station unit further comprises
predetermined time acquiring means for acquiring said predetermined time.

9. The mobile communications system according to claim 8, wherein
said base station unit further comprises
predetermined time determination means for determining said predetermined time and
predetermined time transmission means for transmitting said predetermined time determined to said mobile station unit, wherein
said mobile station unit further comprises
predetermined time reception means for receiving said predetermined time, and wherein
said predetermined time acquisition means acquires said predetermined time by receiving said transmitted predetermined time.

10. The mobile communications system according to claim 4, wherein
said base station unit comprises
means for transmitting an instruction to the mobile station unit to elevate/lower the transmitting power of said mobile station unit in accordance with the receiving error rate of the information code transmitted from said mobile station unit and wherein
said information code transmitting means transmits the information code at a power corresponding to the instruction transmitted from said base station unit.

11. A mobile station unit used in a mobile communications system conforming to the CDMA Standard, wherein
said mobile station unit comprises
transmission rate storage means for storing the transmission rate of a signal transmitted from the mobile station unit,
transmission rate lowering means for lowering the transmission rate of the signal transmitted from the mobile station unit below said transmission rate stored on said transmission rate storage means and
transmission rate recovery means for recovering the transmission rate of the signal transmitted from the mobile station unit to said transmission rate stored on said transmission rate storage means when a predetermined time has elapsed in case said transmission rate lowering means lowers the transmission rate of the signal transmitted from the mobile station unit below said transmission rate stored on said transmission rate storage means.

12. A mobile station unit used in a mobile communications system conforming to the CDMA Standard, wherein
said mobile station unit comprises
information code transmission means for transmitting an information code to a base station unit,
low rate transmission instruction receiving means for receiving the a low rate transmission instruction from said base station unit,
transmission rate change means for changing the transmission rate of the information code in accordance with said low rate transmission instruction,
transmission rate storage means for storing a transmission rate before change in the transmission rate in case said transmission rate change means has changed the transmission rate and
transmission rate recovery means for recovering the transmission rate to a transmission rate according to said transmission rate stored on said transmission rate storage means when a predetermined time has elapsed since the transmission rate was changed.

13. A base station unit used in a mobile communications system conforming to the CDMA Standard, wherein
said base station unit comprises information code reception means for receiving an information code transmitted from a mobile station unit,
determination means for determining that said mobile station unit is transmitting said information code at a transmission rate exceeding a predetermined threshold and
low rate transmission instruction transmitting means for transmitting a low rate transmission instruction to said mobile station unit transmitting said information code at the transmission rate exceeding said predetermined threshold.

14. A transmission rate control method for controlling the transmission rate of a mobile station unit used in a mobile communications system conforming to the CDMA Standard, wherein
said method comprises
a step of storing the transmission rate of a signal transmitted from the mobile station unit onto storage means
a step of lowering the transmission rate of the signal transmitted from said mobile station unit below said transmission rate stored on said transmission rate storage means and
a step of recovering the transmission rate of the signal transmitted from said mobile station unit to said transmission rate stored on said transmission rate storage means when a predetermined time has elapsed in case the transmission rate of the signal transmitted from said mobile station unit is lowered below said transmission rate stored on said transmission rate storage means.

15. A transmission rate control method for controlling the transmission rate of a mobile station unit used in a mobile communications system conforming to the CDMA Standard, wherein
said method comprises a step of receiving an information code transmitted from a mobile station unit,
a step of determining that said mobile station unit is transmitting said information code at a transmission rate exceeding a predetermined threshold and
a step of transmitting a low rate transmission instruction to said mobile station unit transmitting said information code at the transmission rate exceeding said predetermined threshold.
